(19) United States
(12) Patent Application Publication
(10) Pub. No.: US 2024/0052878 A1
(43) Pub. Date: Feb. 15, 2024

(54) CONNECTING ROD HAVING CURVED SLATS

(71) Applicant: HUTCHINSON, Paris (FR)

(72) Inventors: Engin ERTEM, Amilly (FR); Vincent JOSEPH, Montargis (FR); Jean-Christophe RIETSCH, Corbeil-Essonnes (FR); Jean-Michel BUCHIN, Lons-Le-Saunier (FR)

(21) Appl. No.: 18/249,570

(22) PCT Filed: Oct. 15, 2021
(86) PCT No.: PCT/IB2021/059516

§ 371 Date: Sep. 28, 2023

(30) Foreign Application Priority Data
Oct. 23, 2020 (FR) FR2010889

(51) Int. Cl. F16C 7/06; F16C 7/02

(52) U.S. Cl. CPC F16C 7/06; F16C 7/026

(57) ABSTRACT

A connecting rod includes two elastically flexible slats which are curved and arranged symmetrically relative to a longitudinal axis of the connecting rod. The slats have end zones running parallel to the axis, as well as transverse spacers placed between the slats and fasteners for securing the slats to each other and to the transverse spacers. The fasteners include adapters for adjusting the curve of the slats with a view to varying the axial length of the connecting rod.

### CROSS-REFERENCE TO RELATED APPLICATION(S)

This application is a National Stage Application of PCT/IB2021/059516, filed Oct. 15, 2021, which claims benefit of Serial No. FR2010889, filed Oct. 23, 2020, in France, and which applications are incorporated herein by reference. To the extent appropriate, a claim of priority is made to each of the above disclosed applications.

### TECHNICAL FIELD

The invention relates to connecting rods, which are elementary mechanical components designed to transmit forces and movements and which can be subjected to very varied and sometimes significant stresses, depending on the specific functions they perform.

### BACKGROUND OF THE INVENTION

The connecting rods are, in particular, a basic mechanical component in the aeronautical industry, where they are used as the building block in a large number of systems, in which they must of course be highly reliable. They are thus used in flight controls, linear or rotary, and in many control mechanisms, and they may also have a supporting function or a function in the development of the primary structure of the aircraft, etc. They are often distinguished according to whether they are used in the transmission of movements or forces, and may be designed to be of fixed length or adjustable length, in the latter case via mechanisms that make them telescopic and therefore adaptable to diverse technical environments.

### SUMMARY OF THE INVENTION

The mechanical telescopic connecting rods, i.e. with a variable and adjustable centre-axis distance, are used in particular when it comes to transmitting a movement, for example in a flight control system. In general, the length adjustment is achieved by a combination of right and left-hand threads, sometimes combined with a micrometric braking device. Threaded tips are usually used to be mounted on the bodies of the connecting rods.

The current connecting rods, with fixed or adjustable centre distance, are usually made of metal or composite materials. The use of composite materials, offering greater rigidity, is for example preferred for long connecting rods. The same is true when the structural environment itself is made of composite material, which in particular prevents problems of differential linear expansion in the various components.

The energy issues that are very generally raised nowadays, and which apply particularly acutely in the aeronautical industry, are leading the manufacturers to want to favour lightweight components, and consequently composite connecting rods. The conventional connecting rods of adjustable length, requiring a conventional threaded structure in the body of the connecting rod and threaded tips, are not usually made of composite material and are a weight factor.

At the same time, the economic issues are particularly important in the aeronautical industry today, in a world where environmental issues are emerging. The connecting rods with screwed tips are expensive to produce and involve long lead times, which indirectly increase the overall economic burden.

More economical to manufacture, the connecting rods with a fixed centre distance have in most cases tubular bodies with symmetry of revolution, except at the ends where the sections become rectangular. The transition from a tubular to a rectangular cross-section complicates the design and production of parts, particularly when they are made of composite materials.

Nowadays, for all these reasons, the manufacturers—in particular but more specifically in the aeronautical field—are looking to optimise the costs and weights of these parts. The expected economic impacts on the aircrafts are direct, through the decrease in the cost of connecting rods, and indirect, through the reduction that leads to a decrease in operating costs.

The invention thus offers a design and manufacturing alternative that is particularly suitable for connecting rods of adjustable-length, in particular but not exclusively, by means of a technical solution that is economical to produce and that is itself available in a large number of easily implemented variants. The advantages of the invention are particularly noticeable for adjustable configurations, with variations in length being particularly easy to achieve in variants that provide for such adjustment.

Thus, according to the invention, the connecting rod comprises two elastically flexible slats which are curved and arranged symmetrically with respect to a longitudinal axis of the connecting rod, said slats having end zones running parallel to said axis. It also comprises transverse spacer means placed between the slats and means for securing the slats to each other and to the transverse spacer means. The connecting rod of the invention is such that the securing means comprise means for adjusting the curve of the slats in order to vary the axial length of the connecting rod.

The length of the connecting rod is therefore influenced by acting on the securing means which give the connecting rod its mechanical consistency. These are adjustable in particular in a transverse direction, as they allow the curve of the slats to be modified, leading mechanically to a variation in the length of the slats. The adjustment in the tightening direction increases the length of the connecting rod, while loosening results in a springing back of the original curve and a decrease in the length of the connecting rod. In other words, the adjusting means of the securing means for assembling the components of the connecting rod are acted upon to change the axial length of the connecting rod.

Preferably, the adjusting means comprise locking means, which allow the desired adjustment, obtained by acting on the adjusting means of the securing means, to be maintained.

For length adjustment to be possible, in at least some connecting rod configurations, at least part of the spacer means must be elastically or reversibly deformable at least in a direction normal to the longitudinal axis of the connecting rod. On the other hand, if the spacer means are not deformable, no length adjustment can be implemented.

In a first possible configuration, the transverse spacer means may comprise an inner core having a structure with faces facing the slats at least partially embracing the surface of the internal face of the slats. The matching of the surfaces in this core configuration improves the adjustment possibilities as the deformations of the slats are continuously transmitted to the entire inner core structure and vice versa.

Preferably, the structure of the inner core may consist of at least one median crossbeam and two transverse spacers at the end zones of the slats, each crossbeam and the end spacers being connected by spars having the same longitudinal profile as the inner face of the slats. In this configuration, the crossbeams are not attached to the slats over all—or at least most—of their length, and relative slip between the core and the slats can therefore occur.

It should be noted that end spacers can be rigid, and that they maintain a free space between the end zones of the slats. The space between said end zones at each end of the connecting rod need not be impacted by the reduction in transverse thickness during an operation to increase the length of the connecting rod.

Alternatively, the structure of the inner core may be solid, and comprising external faces in contact with and embracing the internal face of the slats, and having a transverse thickness at its ends preserving a free space between the end zones of the slats. Although the structure of the core is compact and unitary, there is nothing to prevent it being made of a deformable material and the fastening means deforming it at least in a median portion of the connecting rod. The deformation in the end zones can be carried out independently if necessary, or not at all if an end space between the slats is to be maintained. The same slip of the external faces of the solid core in contact with the internal faces of the slats is possible at least in a large central portion of the connecting rod.

In yet another configuration, the structure of the inner core may consist of two rigid spacer blocks located in the vicinity of the two end zones and preserving a free space between said end zones. The securing means, which are located in the median portion, only have an influence on the modification of the curve of the slats, leading to a variation in the length of the connecting rod.

The securing means themselves can take various configurations, according to the invention. Thus, in a first variant, said securing means may for example consist of at least one winding of composite wire around the slats, in a plurality of directions making an angle between 35° and 90° with the longitudinal axis. The tightening to increase the length of the connecting rods is then done by working on the tension of the windings

According to another possible variant, the securing means consist of at least one metal strap surrounding the outside of the slats. The logic of lengthening/reducing the length follows the same principle, i.e. a more or less important tightening.

Finally, the securing means may also consist of bolts placed at least in the centre of the slats and in the vicinity of the end zones of the slats. Screws and nuts are thus conveniently placed on and along the connecting rod, so as to allow the variation in length of the connecting rods to be managed according to the existence and position of the spacer means, and their deformability. It should be noted that in this configuration, the securing means are identified with the spacer means, at least in the central portion of the connecting rod, and that their transverse deformability is indeed reversible. The deformation results from the tightening/loosening applied to the bolt.

Such screw-nut systems are adapted to the geometry of the slats, and can be combined with the elastomer if a vibration damping function is to be implemented. To ensure that the adjustment is permanent, at least the bolt or bolts placed in the centre of the slats can be equipped with locking nuts.

Depending on the context of use, and whether or not the function of variability of the length of the connecting rods is required, the slats can for example be made of one of the following materials: composite material such as carbon-fibre reinforced polymer, glass-fibre reinforced polymer, metal such as aluminium or steel.

Similarly, the inner core can, without limitation, be made of one of the following materials: polymer foam including polyurethane foam and thermoplastic polyurethane foam, injected plastic, 3D printed plastic, elastomer, sheet moulding mixture, thermosetting resin mixture, honeycomb made of metal or composite material or plastic, metal, wood.

Further features and advantages of the invention will be apparent from the following detailed description, which relates to particular examples of the embodiment of a connecting rod according to the invention, examples which should not, however, be regarded as limiting the invention.

### BRIEF DESCRIPTION OF THE INVENTION

The understanding of this description will be facilitated in particular by reference to the following figures:

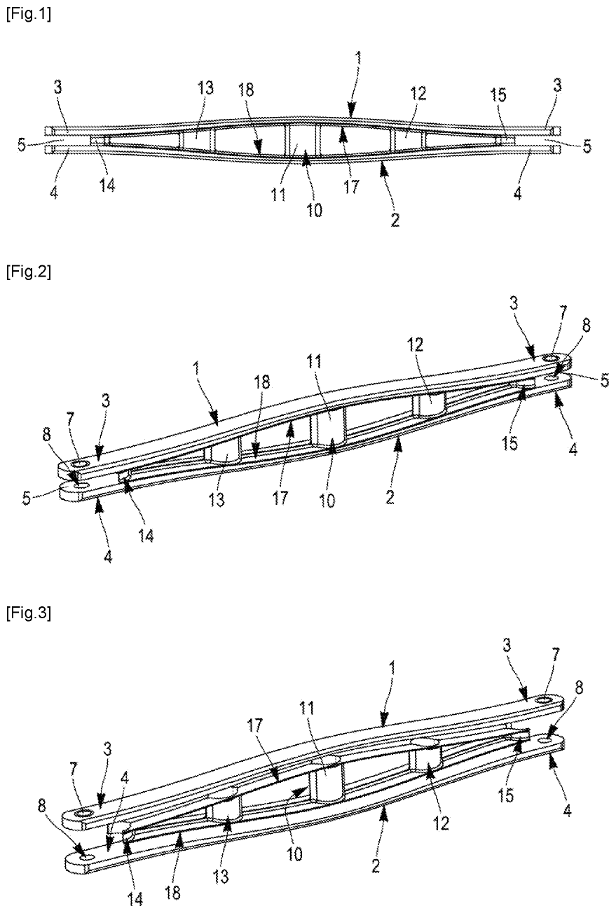

FIG. 1 is an elevation view of a connecting rod according to a first variant of the present invention;

FIG. 2 shows a perspective view of this assembled connecting rod;

FIG. 3 shows an exploded perspective view of the connecting rod in FIG. 2;

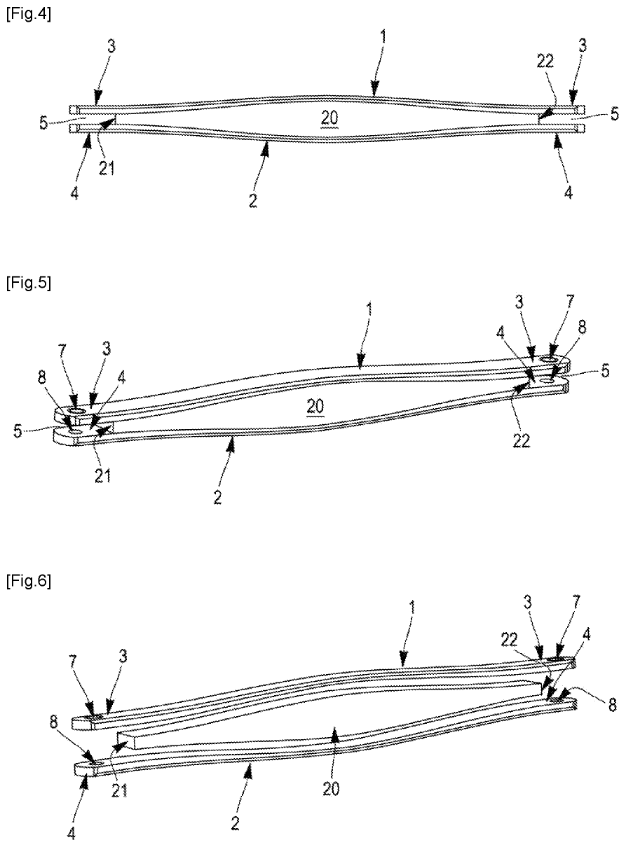

FIG. 4 shows an elevation view of a second variant of the connecting rod according to the invention;

FIG. 5 shows in perspective view the variant of FIG. 4;

FIG. 6 shows it in exploded perspective view;

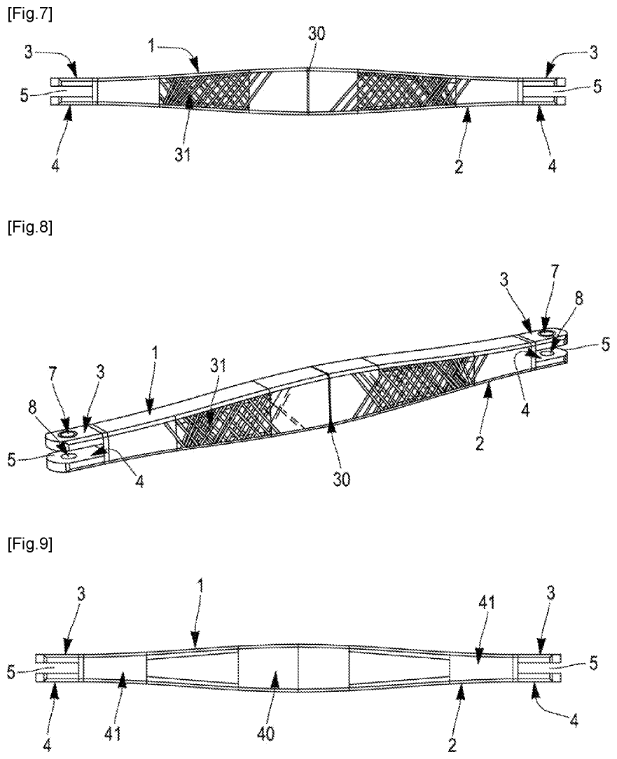

FIG. 7 shows an elevation view of an assembly mode with first fastening means with composite wire winding(s);

FIG. 8 shows the configuration of FIG. 7 in perspective;

FIG. 9 illustrates, in an elevation view, another fastening mode, with strapping;

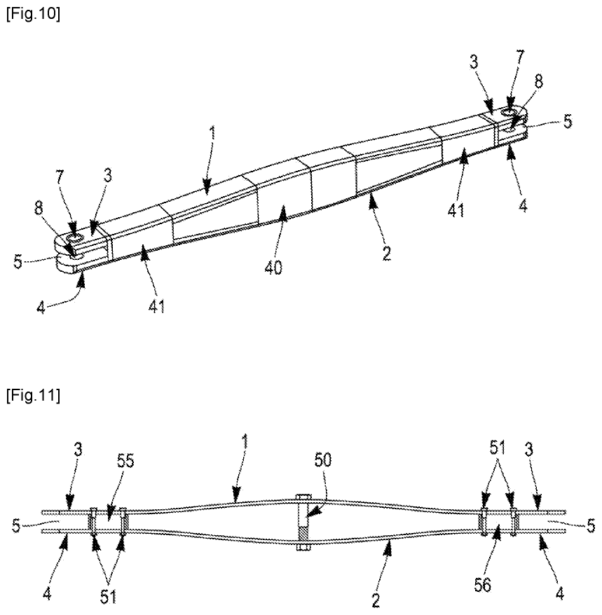

FIG. 10 shows the configuration of the previous figure, in perspective view;

FIG. 11 shows an elevation view of a third variant of the connecting rod according to the invention;

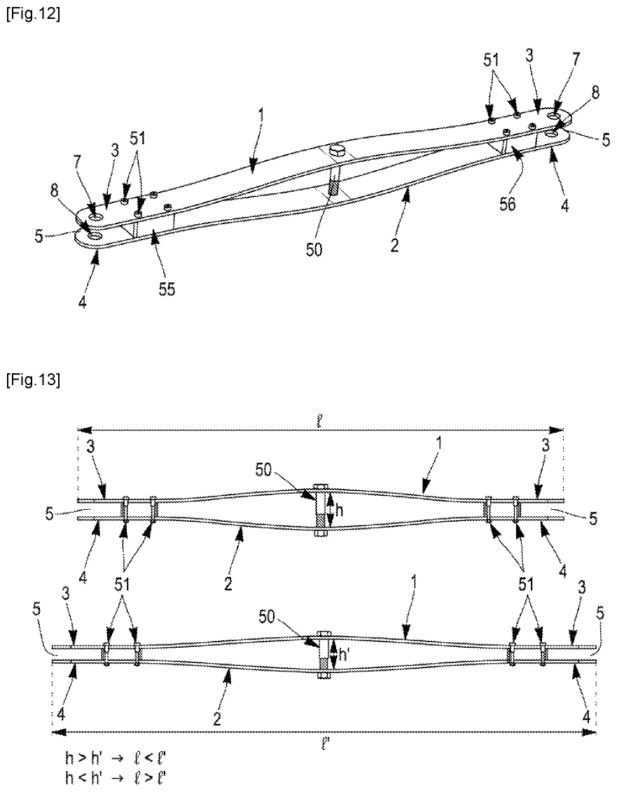

FIG. 12 shows the version of FIG. 11 in perspective view; and

FIG. 13 illustrates the variation in length of a connecting rod according to the invention as a function of the adjustment of the fastening means.

### DETAILED DESCRIPTION OF THE INVENTION

With reference to FIGS. 1 to 3, the connecting rod of the invention consists of two slats 1, 2 curved towards the outside which have end zones 3, 4 running parallel to each other, leaving a space 5 between them in the manner of a clevis. The slats 1, 2 are arranged symmetrically at least with respect to a median plane passing between the slats 1, 2 or even with respect to a longitudinal axis of the connecting rod. These end zones 3, 4 are provided with holes 7, 8 which, due to the aforementioned symmetry, are coaxial and which allow the implementation of a rotary connection, if necessary with other connecting rod type elements.

In the first variant of FIG. 1, the inner core 10, particularly visible in FIG. 3, has a structure with crossbeams 11, 12 and 13 and end spacers 14, 15 connected by two crossbeams 17, 18, the external profile of which embraces that of the portions of the internal faces of the slats 1, 2 with which they are in contact. In the configuration shown, the crossbeams 17, 18 are symmetrical with respect to a median plane normal to the aforementioned plane, passing the longitudinal median line of each slat 1, 2. The end spacers 14, 15 are located at the edge of the spaces defined by the end zones 3, 4 of the slats 1, 2.

The variant in FIGS. 4 to 6 is identical in terms of the slats and their relative arrangement, the only difference being the inner core 20, which is solid as shown in FIG. 6 in particular. The two free ends 21, 22 of this solid core 20 have a thickness/cross-sectional dimension that preserves the space 5.

FIGS. 7 and 8 do not prejudge the nature and configuration of the inner core of the connecting rod, and show the appearance of the composite wire winding(s) which form(s) the means for securing the slats to each other and to the structure off the inner core. In a central part of the connecting rod, the wires 30 are oriented in a direction perpendicular to the longitudinal axis of the connecting rod, whereas when approaching the end zones, the wires 31 have angles between 35° and 90°. The angles bounding this interval may be lower and higher respectively, but those mentioned are considered preferential.

The securing means shown in FIGS. 9 and 10 are made of metal or composite straps in the manner of barrels. Straps 41 is again arranged at the edges of the end zones 3, 4, completing straps 40 running more central.

In the two hypotheses of securing means described above, the possibility of adjusting the length of the connecting rod depends on the nature of the material(s) constituting the inner core. If it is deformable at least in the transverse direction, the length may vary depending on the degree of tightness of the coiled wires or straps.

The same applies to the bolted securing shown in FIGS. 11 and 12, which may allow transverse tightening/loosening by means of the bolt 50 (alternatively, there may be several bolts, in one or more rows, or technical equivalents to bolts). It should be noted that, in the variant shown, the inner core is double 55, 56 and does not include a central element, which is technically not always necessary, depending on the context and the mechanical constraints of use. It is therefore not unitary, unlike the previous configurations. The structure of this core has end blocks 55, 56 which are also bolted on by smaller screws/nuts 51, which always fix them at the edge of the spaces 5. These blocks 55, 56 are in most cases rigid, with the length adjustments having a much more limited range at these locations on the connecting rod. A fastening with e.g. 4 bolts (the number of bolts used can be more or less) is moreover hardly practical to implement such an adjustment.

FIG. 13 is intended to show explicitly the length adjustment of a connecting rod that the invention allows. Thus, with the securing means and configuration of FIGS. 11 and 12, it is sufficient to tighten the bolt 50 to extend the connecting rod. The length h between slats of the bolt 50 decreases and becomes h′, h′<h. As can be seen in the figure, the length 1′ of the connecting rod after tightening is then greater than the initial length 1: 1′>1. The reverse operation of loosening the bolt 50 leads to the opposite result. As mentioned, such a configuration results in the conflation of the securing and spacer means, at least in the centre of the connecting rod, and it is therefore these unified means that are reversibly deformable in a direction normal to the longitudinal axis of the connecting rod.

The advantage of the present invention lies in the fact that it is particularly simple and economical to manufacture, with mechanical performances that are as high or even higher than in current configurations that are much more complex and expensive to produce.

Although the invention has been described in relation to particular embodiments in the form of alternative embodiments, it is understood that it is by no means limited thereto, the examples not being exhaustive of the possible configurations.

Various modifications of form and/or materials can be made, and these various elements can be combined without departing from the framework and spirit of the invention. Thus, the different fastening means of FIGS. 7-8, 9-10 and 11-12 respectively can be applied to the spacer means of FIGS. 1-3 and 4-6, or even 11-12 respectively. The combinations are multiple and non-limiting, including mechanical systems such as bolts or chemical systems such as foam cross-linking to help lock the connecting rod in place in one length etc.

1. A connecting rod comprising two elastically flexible slats which are curved and arranged symmetrically with respect to a longitudinal axis of the connecting rod, said slats having end zones running parallel to said axis, as well as a transverse spacer placed between the slats and a fastener for securing the slats to each other and to the transverse spacer, wherein the fastener comprises an adjuster for adjusting the curve of the slats (1, 2) with a view to vary an axial length of the connecting rod.

2. The connecting rod according to claim 1, wherein the comprises a lock.

3. The connecting rod according to claim 2, wherein at least part of the spacer is elastically or reversibly deformable at least in a direction normal to the longitudinal axis of the connecting rod.

4. The connecting rod according to claim 1, wherein the transverse spacer comprises an inner core having a structure, faces of of the structure that are facing the slats at least partially embrace a surface of an internal face of the slats.

5. The connecting rod according to claim 4, wherein the structure of the inner core comprises at least one median crossbeam and two transverse spacers at the end zones of the slats, each crossbeam and the end spacers being connected by spars having a same longitudinal profile as the internal face of the slats.

6. The connecting rod according to claim 5, wherein the end spacers are rigid and maintain a free space between the end zones of the slats.

7. The connecting rod according to claim 4, wherein the structure of the inner core is solid and comprises external faces in contact with and embracing the internal face of the slats, and having a transverse thickness at its ends preserving a free space between the end zones of the slats.

8. The connecting rod according to claim 4, wherein the structure of the inner core comprises two rigid spacer blocks located in the vicinity of the two end zones and preserving a free space between said end zones.

9. The connecting rod according to claim 1, wherein the fastener comprises at least one winding of composite wire around the slats, in a plurality of directions making an angle of between 35° and 90° with the longitudinal axis.

10. The connecting rod according to claim 1, wherein the fastener comprises at least one metal strap surrounding an outside of the slats.

11. The connecting rod according to claim 1, wherein the fastener comprises bolts placed at least in a center of the slats and in the vicinity of the end zones of the slats.

12. The connecting rod according to claim 11, wherein at least the bolt or bolts placed in the center of the slats are equipped with locking nuts.

13. The connecting rod according to claim 1, wherein the slats are made of one of the following materials: composite material comprising carbon-fiber reinforced polymer, glass-fiber reinforced polymer, metal comprising aluminum or steel.

14. The connecting rod according to claim 1, wherein the inner core is made of one of the following materials: polymer foam including polyurethane foam and thermoplastic polyurethane foam, injected plastic, 3D printed plastic, elastomer, sheet molding mixture, thermosetting resin mixture, honeycomb made of metal or composite material or of plastic, metal, wood.
